(19) United States
(12) Patent Application Publication
(10) Pub. No.: US 2015/0325837 A1
(43) Pub. Date: Nov. 12, 2015

(54) LITHIUM-METAL OXIDE NANOPARTICLES, PREPARATION METHOD AND USE THEREOF

(71) Applicant: ROBERT BOSCH GMBH, Stuttgart (DE)

(72) Inventor: Yongyao Xia, Changning, Shanghai (CN)

(73) Assignee: Robert Bosch GmbH, Stuttgart (DE)

(21) Appl. No.: 14/367,578

(22) PCT Filed: Dec. 30, 2011
(86) PCT No.: PCT/CN2011/085045

§ 371 Date: Jul. 8, 2015

(51) Int. Cl. H01M 4/131; H01M 4/525; H01M 4/505; C01G 53/00

(52) U.S. Cl. CPC H01M 4/131; C01G 53/50; H01M 4/525; H01M 4/505; C01P 2004/64; C01P 2004/62; C01P 2006/40; H01M 2004/028

(57) ABSTRACT

Provided are a lithium-metal oxide nanoparticles and the preparation method thereof. The lithium-metal oxide nanoparicles have a general formula: xLi₂MnO₃.(1-x)LiNi_{y}Co_{z}Mn₁-_{y}-_{z}O₂, where 0<x<1, 0<y<1, 0<z<1, wherein the nanoparticles have a primary particle size ranging from 50 nm to 500 nm. The preparation method comprises reacting a mixture comprising transition metal compounds of manganese (Mn), nickel (Ni) and cobalt (Co), and a lithium compound in a molten salt used as a reaction medium, wherein the respective transition metal compounds are selected from the group consisting of oxides and salts of Mn, Ni, and Co; the lithium compound is selected from the group consisting of lithium oxides and lithium salts. Also provided are a cathode material for a lithium ion battery comprising the lithium-metal oxide nanoparticles and a lithium ion battery comprising the lithium-metal oxide nanoparticles.

### FIELD OF THE INVENTION

The present invention relates to lithium-metal oxide nanoparticles having a general formula of xLi₂MnO₃.(1-x)LiNi_{y}Co_{z}Mn_{1-y-z}O₂, and their preparation method, and also to their use as cathode materials for lithium ion batteries.

### BACKGROUND OF THE INVENTION

Lithium-metal oxide compound of the general formula LiMO₂, where M is a trivalent transition metal such as Co, Ni or/and Mn, is of interest as cathode material for lithium-ion battery. The best well-known cathode material is LiCoO₂, which is however relatively expensive compared to the isostructual nickel and manganese-based compounds. Efforts have therefore been made to develop less costly cathode materials, for example, by partially substituting the cobalt ions within LiCoO₂ by nickel or manganese.

U.S. Pat. No. 6,680,143B2 describes a lithium metal oxide positive electrode having a general formula xLiMO₂.(1-x)Li₂M′O₃ (0<x<1) where M is one or more ions with an average trivalent oxidation state with at least ion being Mn or Ni, and M′ is one or more ions with an average tetravalent oxidation state. The lithium metal oxide however has a relatively poor crystal structure. The lithium-metal oxide compound has the following problems: (1) a low coulombic efficiency of the first cycle ascribable to large irreversible capacity loss; (2) a poor rate capability caused by kinetic problems; (3) a rapid capacity fading during cycles.

Therefore, there remains a need for a lithium-metal oxide compound for use as cathode material for a lithium ion battery, which overcomes the above-mentioned shortcomings, while having high energy density, excellent thermal stability and low cost.

### SUMMARY OF THE INVENTION

According to one aspect of the invention, there is provided lithium-metal oxide nanoparticles having a general formula xLi₂MnO₃.(1-x)LiNi_{y}Co_{z}Mn_{1-y-z}O₂ where 0<x<1, 0<y<1, 0<z<1, wherein the nanoparticles have a primary particle size ranging from 50 nm to 500 nm.

According to a further aspect of the invention, there is provided a molten-salt method of preparing the lithium-metal oxide nanoparticles, comprising reacting a mixture comprising transition metal (TM) compounds of manganese (Mn), nickel (Ni) and cobalt (Co), and a lithium compound in a molten salt (MS), wherein the respective transition metal compounds are selected [symbol] consisting of oxides and salts of Mn, Ni, and [symbol] pound is selected from the group consisting of lithium oxides and lithium salts.

According to a further aspect of the invention, there is provided a cathode material for a lithium ion battery comprising the lithium-metal oxide nanoparticles.

According to a further aspect of the invention, there is provided a lithium ion battery comprising the lithium-metal oxide nanoparticles as cathode materials.

The nanoparticles having the general formula of xLi₂MnO₃.(1-x)LiNi_{y}Co_{z}Mn_{1-y-z}O₂ according to the invention show significant improvement in specific capacity, rate capability and coulombic efficiency at the first cycle.

### BRIEF DESCRIPTION OF THE DRAWINGS

These and/or other aspects and advantages of the invention will become apparent and more readily appreciated from the following description of the invention, taken in conjunction with the accompanying drawings, in which,

FIG. 1 is a graph showing X-ray diffraction pattern of Li_{1.2}Mn_{0.54}Ni_{0.13}Co_{0.13}O₂ prepared according to Example 2.

FIG. 2 is a graph showing X-ray diffraction pattern of Li_{1.2}Mn_{0.54}Ni_{0.13}Co_{0.13}O₂ prepared according to Comparative Example 1.

FIG. 3 is SEM image of Li_{1.2}Mn_{0.54}Ni_{0.13}Co_{0.13}O₂ prepared according to Example 2.

FIG. 4 is SEM image of Li_{1.2}Mn_{0.54}Ni_{0.13}Co_{0.13}O₂ prepared according to Comparative Example 1.

FIG. 5 shows the typical voltage vs. capacities curve of Li_{1.2}Mn_{0.54}Ni_{0.13}Co_{0.13}O₂ prepared according to Example 2.

FIG. 6 shows the rate performance of Li_{1.2}Mn_{0.54}Ni_{0.13}Co_{0.13}O₂ prepared according to Example 2 at various rates.

### DETAILED DESCRIPTION OF THE PREFERRED EMBODIMENTS

According to the invention, the lithium-metal oxide nanoparticles have a general formula: xLi₂MnO₃.(1-x)LiNi_{y}Co_{z}Mn_{1-y-z}O₂, in which 0<x<1, 0<y<1, and 0<z<1. In a preferred embodiment, x is from [symbol] a further preferred embodiment, y is from 0.2 to [symbol] preferred embodiment, z is from 0.1 to 0.5.

The nanoparticles according to the invention have a primary particle size ranging from 50 nm to 500 nm, preferably from 50 nm to 200 nm.

The nanoparticles can be prepared by a molten-salt method according to the invention, comprising reacting a mixture including transition metal compounds of manganese (Mn), nickel (Ni) and cobalt (Co), and a lithium compound in a molten salt.

As precursors of the transition metals, the transition metal compounds are selected from the group consisting of transition metal oxides and transition metal salts. Exemplary transition metal salts include, but are not limited to, carbonate, nitrate, acetate, oxalate, hydrate and sulfate.

As lithium precursor, the lithium compound is selected from the group consisting of lithium oxides and lithium salts. Examplary lithium salts include, but are not limited to, lithium carbonate, lithium hydroxide, lithium nitrate and lithium sulfate.

The molten-salt method is based on the use of a salt with a low melting point as a reaction medium. The salt is not particularly restricted. Examples of the salt include, but are not limited to, lithium carbonate, lithium hydroxide, lithium nitrate, lithium chloride, sodium chloride, potassium chloride, magnesium chloride, calcium chloride, barium chloride, sodium nitrate, and potassium nitrate. Preferably, potassium chloride, lithium nitrate, and lithium chloride are used as the salt.

The reaction can be carried out by mixing stoichiometric amounts of the transition metal compounds and the lithium compound, grinding the mixed compounds with an excess of the salt as described above used as a reaction medium, and heating the mixture at a temperature of from 600° C. to 1000° C., under an oxygen-containing atmosphere, for example, under a flow of air or oxygen gas, for a period of from 1 h to 48 h.

It has been found that the amount of the molten salt used as a reaction medium in the method may influence the formation of the nanoparticles. As the amount of the molten salt increases, the average particle size becomes small. In the method according to the invention, the salt can be suitably used in a molar ratio to the total transition metals (MS/TM) of from 2 to 32.

The obtained product is then cooled, for example by liquid nitrogen quenching. After cooling, the product is washed to remove residual molten-salt, and then dried.

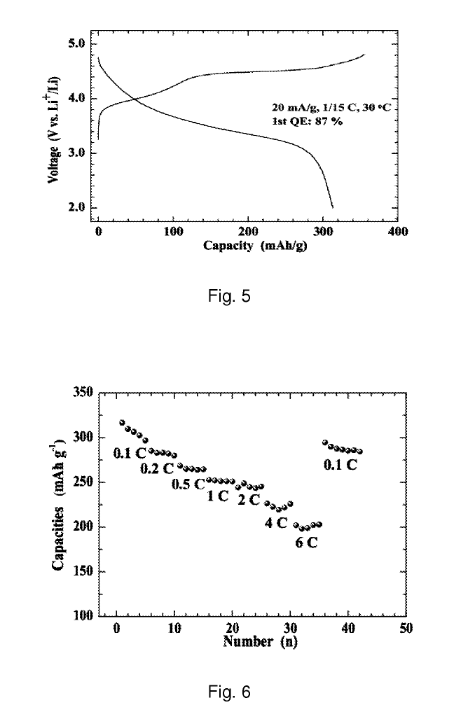

By [symbol] method according to the invention, the nanopar [symbol] crystallinity can be obtained. The obtained nanoparticles show improved specific capacity, rate capability, and coulombic efficienty at the first cycle, as illustrated in FIGS. 5 and 6. The nanoparticles can be advantageously used as cathode materials for lithium-ion batteries.

The following examples further illustrate the preparation of the nanoparticles by the molten-salt method according to the invention, and the characteristics of the prepared nanoparticles used as cathode material for lithium-ion battery. The examples are given by way of illustration only, and are not intended to limit the invention in any manner.

### EXAMPLE 1

### Preparation of xLi₂MnO₃.(1-x)LiNi_{y}Co_{z}Mn_{1-y-z}O₂ Powder (x=0.5; y=1/3; z=1/3)

A stoichiometric amount of lithium nitrate, Ni, Mn and Co oxides were thoroughly mixed. The mixed precursors were ground with a large excess of lithium nitrate salt (LiNO₃) of which the molar ratio for the total transition metals (MS/TM) was 4. The mixture of LiNO₃ salt and the precursors was put in an alumina crucible and heated at 950° C. in air for 6 h. The powder having a particle size of 400-500 nm was obtained after liquid nitrogen quenching.

### EXAMPLE 2

### Preparation of xLi₂MnO₃.(1-x)LiNi_{y}Co_{z}Mn_{1-y-z}O₂ Powder (x=0.5; y=1/3; z=1/3)

The powder precursors were synthesized using a stoichiometric amount of LiOH, Ni, Mn and Co oxides which were thoroughly mixed. The mixed precursors were ground with potassium chloride salt (KCl) of which the molar ratio for the total transition metals (MS/TM) was 32. The mixture was put in an alumina crucible and heated at 800° C. in air for 12 h. The powder having a particle size of 100-200 nm was obtained after liquid nitrogen quenching.

### EXAMPLE 3

### Preparation of xLi₂MnO₃.(1-x)LiNi_{y}Co_{z}Mn_{1-y-z}O₂ Powder (x=0.3; y=1/3; z=1/3)

A stoichiometric amount of lithium chloride, Ni, Mn and Co oxides were thoroughly mixed. The mixed precursors were ground with a large excess of lithium chloride salt (LiCl) of which the molar ratio for the total transition metals (MS/TM) was 4. The mixture of LiCl salt and the precursors was put in an alumina crucible and heated at 650° C. in air for 12 h. The powder having a particle size of 50-200 nm was obtained after cooling to room temperature.

### COMPARATIVE EXAMPLE 1

### Preparation of xLi₂MnO₃.(1-x)LiNi_{y}Co_{z}Mn_{1-y-z}O₂ Powder (x=0.5; y=1/3; z=1/3) by a Solid-State Reaction Process

The powder precursors were synthesized using a stoichiometric amount of Li₂CO₃, Ni, Mn and Co oxides which were thoroughly mixed. The mixture was put in an alumina crucible and heated [symbol] for 12 h. The powder having a particle size of 400 [symbol] after liquid nitrogen quenching.

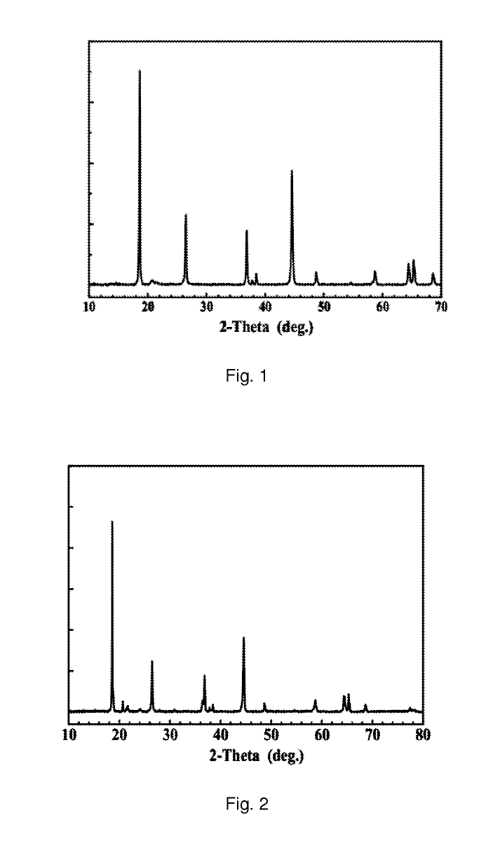

The chemical composition and crystalline phase of the powders prepared according to Example 2 and according to Comparative Example 1 were determined by X-ray diffraction (XRD) measurement. The XRD pattern of the powder prepared according to Example 2, as shown in FIG. 1, indicates an essentially single-phase product. In contrast, the XRD pattern of the powder prepared according to Comparative Example 1, as shown in FIG. 2, indicates a mixed-phase product. From the XRD pattern as shown in FIG. 1, the chemical composition of the powder prepared according to Example 2 was indexed to be α-NaFeO₂ type structure, space group R 3̅m.

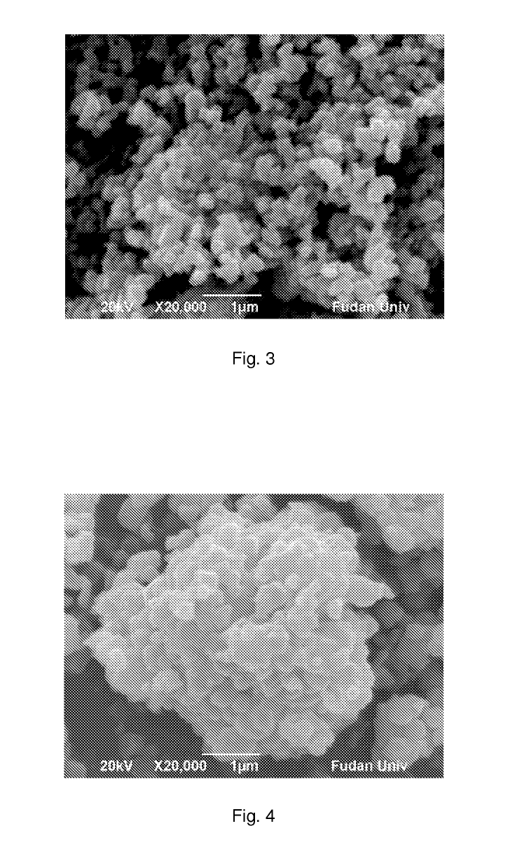

The particle morphology of the powders was observed by a scanning electron microscopy (SEM). FIG. 3 shows the SEM image of the powder prepared according to Example 2. From the SEM image, it can be seen that discrete nanoparticles having a particle size of 100-200 nm were obtained by the molten-salt method according to the invention. In contrast, FIG. 4 shows the SEM image of the powder prepared according to Comparative Example 1. From the SEM image, severe agglomeration was observed, and the powder having a particle size of from 400 nm to 1 μm was obtained by the solid-state reaction process.

### Cell Assembling and Electrochemical Tests

The cathode consisted of the following active materials: xLi₂MnO₃.(1-x)LiNi_{y}Co_{z}Mn_{1-y-z}O₂ powder prepared according to Example 2, carbon black and polyvinylidene fluoride (PVDF) (with a weight ratio of 80˜94:10˜3:10˜3). Then, a solvent, N-methyl-2-pyrrolidone (NMP), was added to these active materials, forming a slurry. The slurry was then uniformly coated on an aluminum foil, dried at 100° C. under vacuum for 10 h, pressed and cut into 12 mm cathode discs. Coin cells (CR2016) were assembled using metallic Li as the counter electrode, Celgard 2400 as the separator, and 1 mol I⁻¹ LiPF₆ as the electrolyte, in an Ar-filled glove box. The cycling performances of the cells were evaluated by using a Land CT2001A battery tester between 2.0V and 4.8V versus Li/Li⁺. The test results are shown in FIGS. 5 and 6.

As shown in FIGS. 5 and 6, the nanoparticles according to the invention deliver a capacity of about 300 mAh g⁻¹ at room temperature at the current density of 20 mA/g with 89% coulombic efficiency at the first cycle. When discharged at 6 C, the Li_{1.2}Mn_{0.54}Ni_{0.13}Co_{0.13}O₂ nanoparticles show a capacity of 200 mAh g⁻¹.

1. Lithium-metal oxide nanoparticles having a general formula:
xLi₂Mn0₃.(1-x)LiNi_{y}Co_{z}Mn_{1-y-z}O₂,
where 0<x<1, 0<y<1, 0<z<1,
wherein the nanoparticles have a primary particle size ranging from 50 nm to 500 nm.

2. The lithium-metal oxide nanoparticles according to claim 1, wherein x is from 0.3 to 0.7.

3. The lithium-metal oxide nanoparticles according to claim 1, wherein y is from 0.2 to 0.8.

4. The lithium-metal oxide nanoparticles according to claim 1, wherein z is from 0.1 to 0.5.

5. The lithium-metal oxide nanoparticles according to claim 1, wherein the nanoparticles have a primary particle size ranging from 50 nm to 200 nm.

6. A molten-salt method of preparing lithium-metal oxide nanoparticles having a general formula xLi₂Mn0₃.(1-x)LiNi_{y}Co_{z}Mn_{1-y-z}O₂, where 0<x<1, 0<y<1, 0<z<1, the nanoparticles having a primary particle size ranging from 50 nm to 500 nm, the method comprising:
reacting a mixture comprising transition metal compounds of manganese, nickel and cobalt, and a lithium compound in a molten salt used as a reaction medium,
wherein the respective transition metal compounds are selected from oxides and salts of manganese, nickel, and cobalt, and
wherein the lithium compound is selected from the group consisting of lithium oxides and lithium salts.

7. The method according to claim 6, wherein the reaction is carried out at a temperature of 600 to 1000° C.

8. The method according to claim 6, wherein the respective transition metal compounds are selected from oxides, carbonates, nitrates, acetates, oxalates, hydrates and sulfates of manganese, nickel, and cobalt.

9. The method according to claim 6, wherein the lithium compound is selected from lithium oxide, lithium carbonate, lithium hydroxide, lithium nitrate, and lithium sulfate.

10. The method according to claim 6, wherein the molten salt is selected from potassium chloride, lithium nitrate, and lithium chloride.

11. The method according to claim 6, wherein the molar ratio of the molten salt to total transition metals is 2-32.

12. The lithium-metal oxide nanoparticles according to claim 1, wherein the nanoparticles are included in a cathode material for a lithium ion battery.

13. A lithium ion battery, comprising:
lithium-metal oxide nanoparticles as cathode materials, the lithium-metal oxide nanoparticles having a general formula xLi2Mn03.(1-x)LiNiyCozMn1-y-zO2, where 0<x<1, 0<y<1, 0<z<1,
wherein the nanoparticles have a primary particle size ranging from 50 nm to 500 nm.
